(19) United States
(12) Patent Application Publication
(10) Pub. No.: US 2014/0019190 A1
(43) Pub. Date: Jan. 16, 2014

(54) Process Advisor

(71) Applicants: Udo Arend, Heidelberg (DE); Johan Christiaan Peters, Sankt Leon-Rot (DE)

(72) Inventors: Udo Arend, Heidelberg (DE); Johan Christiaan Peters, Sankt Leon-Rot (DE)

(21) Appl. No.: 13/548,073

(22) Filed: Jul. 12, 2012

(51) Int. Cl. G06Q 10/06

(52) U.S. Cl. 705/7.26

(57) ABSTRACT

In one aspect, there is provided a method. The method may include accessing a process model defining a business process including a plurality of steps including at least one activity and at least one object; accessing a process monitor to obtain a state of the business process including the plurality of steps including the at least one activity and the at least one object; generating a first view including the plurality of steps including the at least one activity and the at least one object and further including the state of the business process; and generating, based on the state, a second view to guide execution of the business process. Related systems, methods, and articles of manufacture are also disclosed.

### TECHNICAL FIELD

The subject matter described herein relates generally to data processing.

### BACKGROUND

The inherent complexity of business scenarios, which can include one or more business processes, and their implementation in business software solutions, enterprise resource planning (ERP) systems, and the like can present substantial challenges to users and can be a serious obstacle to widespread operative use of process and scenario models in the software landscape. Indeed, these complex business processes may include dozens, if not hundreds or more, steps, making it difficult for the end-user and the enterprise to manage. Moreover, these processes can be represented with process modeling notations (e.g., business process modeling notation (BPMN) editors and process engines, enhanced process chains (EPC), modeling hierarchies built on these or similar model types, etc.) but these types of resources are typically difficult for a non-technical user to understand and use.

### SUMMARY

In one aspect, there is provided a method. The method may include accessing a process model defining a business process including a plurality of steps including at least one activity and at least one object; accessing a process monitor to obtain a state of the business process including the plurality of steps including the at least one activity and the at least one object; generating a first view including the plurality of steps including the at least one activity and the at least one object and further including the state of the business process; and generating, based on the state, a second view to guide execution of the business process.

In some variations one or more of the following features can optionally be included in any feasible combination. The accessing may further comprise determining, by the process monitor, the state of the business process during runtime to determine a runtime state of the business process. The at least one object may comprise one or more of the following: a document, a link to an application, an application, a query, a work list, and a data item. A selection may be received of a graphical element at a user interface, wherein the received selection triggers at least generating the first view. A selection may be received of a graphical element at a user interface, wherein the received selection corresponds to the at least one activity. The generating of the second view may be triggered based on the received selection.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1A and 1B show examples of views generated by a process advisor to guide a user through a complex business process;

FIG. 1C shows a view of a user interface illustrating a scenario-centric business scenario landscape overview view;

FIG. 2 shows another view of a user interface illustrating a scenario-centric business scenario landscape overview view based on a newly selected business scenario;

FIG. 3 shows another view of a user interface illustrating a structured business scenario detail view;

FIG. 4 is a process flow diagram illustrating aspects of a method having one or more features consistent with implementations of the current subject matter;

FIG. 5 is a diagram illustrating aspects of a system showing features consistent with implementations of the current subject matter;

FIG. 6 is a diagram illustrating aspects of a system showing features consistent with implementations of the current subject matter; and

FIG. 7 is a diagram illustrating a data repository showing features consistent with implementations of the current subject matter.

When practical, similar reference numbers denote similar structures, features, or elements.

### DETAILED DESCRIPTION

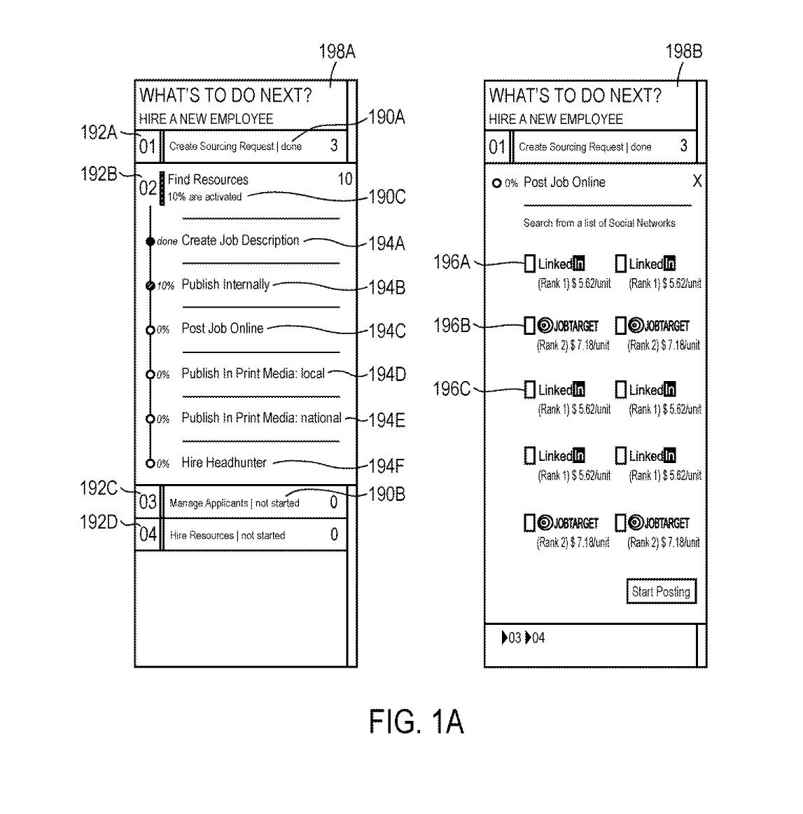

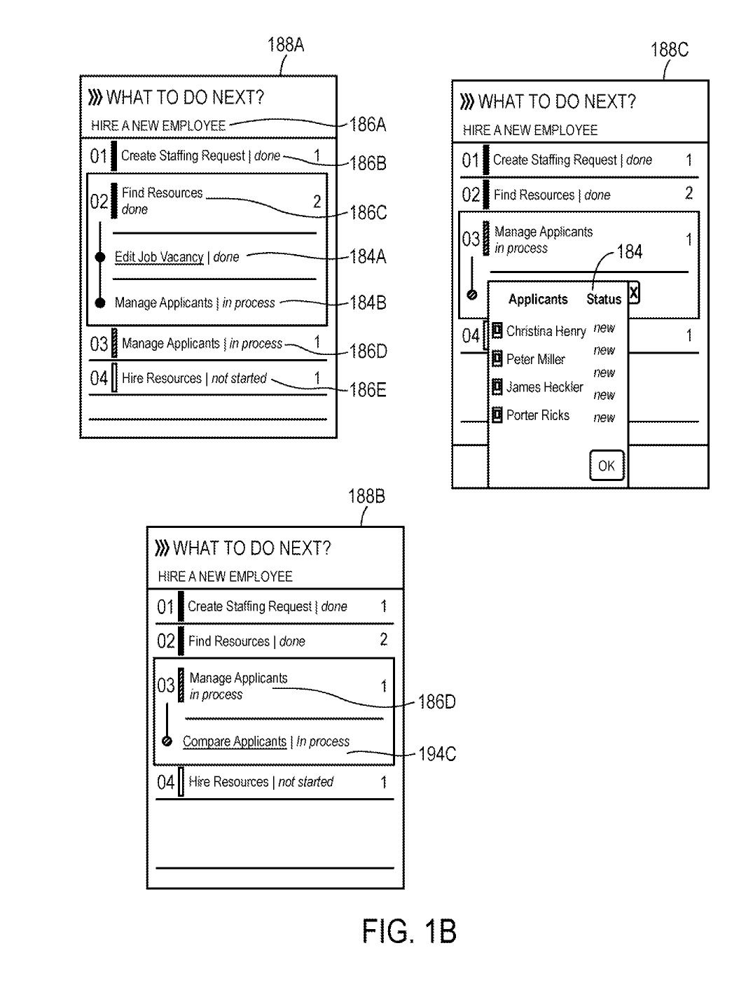

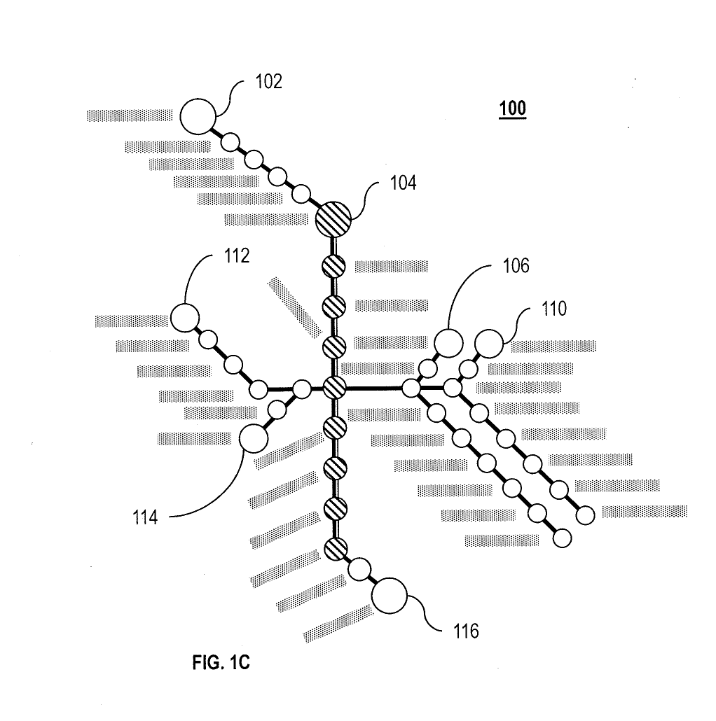

The subject matter disclosed herein relates to a process advisor used to guide a user through a business process executed via a business system, such as an enterprise resource planning system. FIG. 1A depicts examples of views 198A and 108B generated by a process advisor to guide a user through the business process. Referring to FIG. 1A, the business process may include one or more steps, such as steps 192A-D, and each of the steps may include one or more activities (e.g., sub-tasks), such as activities 194A-F. The process advisor may generate the one or more views 198A-B (e.g., pages, such as hypertext markup language pages) to guide a user through a business process. The process advisor may comprise a process model defining the process (or processes) being guided by the process advisor, and a process monitor to keep track of the runtime state of the process.

In the example of FIG. 1A, the process advisor generates page 198A representative of a process for hiring a new employee. The page 198A represents a process that includes one or more steps, such as create a sourcing request 192A, find resources 192B, manage applicants 192C, and hire resources 192D. Each step may also present information regarding the state of the step, such as done 190A, not started 190B, amount of overall task completed 190C, and the like. Every process step may include a list of possible activities, each of which may include objects, such as documents, work lists (e.g., of one or more tasks), queries, applications, data, tools, responsible users/persons, and the like.

View 198A may be generated by the process advisor, which may be at in the network (or in the back end), although the process advisor may be located in other locations as well. Moreover, the generated view 198A may be presented by a user interface, such as a browser, thin client, and the like, at a client computer. In any case, the process advisor may include or access a process model to define the steps, activities, objects and the like, associated with a business process being executed at a business system, and a process monitor to track the runtime execution of the process being modeled.

In the example of FIG. 1A, post job online activity 194C is selected at the user interface. In this example, process advisor may generate another view, such as view 198B based on the process model defining the objects associated with the activity 194C and the process monitor providing the state of the execution of the activity 194C. For example, the process model may define objects 196A-C and so forth for use with the activity 194C, and the objects 196A-C, when selected, may guide the user through a posting of the job at a site associated with the objects 196A-C. The selection of activity 194C may also trigger queries of a repository containing the appropriate objects 196A-C defined by the process model for activity 194C. The process advisor may also filter objects associated with an activity based on previous actions. The process monitor may track the progress of the activities, and may update the amount of activity completed information at 190D.

In some implementations, the process advisor is implemented in a collaborative framework, such as a collaborative cloud framework, although stand-alone implementations of the process advisor may also be used. Moreover, the process advisor may, in some implementations, include a repository in the cooperative cloud to store objects, activities, tasks, and other data associated with the process model(s) being used by the process advisor.

FIG. 1B depicts additional examples of views 188A-C presenting a business process for hiring a new employee 186A. In this example, the business process represents hiring a new employee 186A, which includes steps, such as creating a staffing request 186B, finding resources 186C, managing applicants 186D, and hiring resources 186E. In this example, selecting activity, the step create staffing request 196B is “done,” so the process advisor hides (or collapses) the activities of that step, and expands the activities 194A-B for the step in progress, which is find resources 186C. This process may be defined in the process model.

Moreover, the view 188A may also include status information. For example, the create staffing request 186B includes the status information “done,” the find resources includes status of “done, and the manage applicants includes a status of “in progress.” This status information may be obtained by the process monitor by querying a resource planning system to obtain the current statue of steps, activities, and/or objects.

Page 188B shows the process advisor guiding the user through the manage applicants step 186D. In this example, the create staffing request 186B step is “done,” so the process advisor hides (or collapses) the activities of that step, and expands the activity 194C of the step in progress, which is create staffing request 186B. The process advisor may access the process monitor to determine the status of steps and/or activities in order to expand and collapse steps in a view and update the status information for the steps/activities.

View 188C shows an example object comprising an object work list 184 based on a query to a resource planning system containing the items on the work list and their state (or status). For example, during the step manage applicants 186D, the applicants may each correspond to a data structure or object stored in a repository, and the corresponding status of each applicant may be presented in the work list 184 (e.g., new, previously evaluated, recommend hire, etc.).

In some implementations, the process advisor may one present the steps a given user is required to perform and guides the user through the process by expanding and collapsing steps or activities as they are completed. For example, the process presented by process advisor may be configured to present one or more tasks for a user based on the user's role and any corresponding assigned steps and/or activities. Moreover, when a process step is completed, the process advisor may collapse the previous steps. For example, in view 188B, the find resources step is done, so it collapses in favor or the step currently being performed.

Although FIGS. 1A-1B were described with respect to a business process associated with a recruiting function, any other type of business process executed by a business system, such as an enterprise resource planning system and the like, may be used as well.

In some exemplary implementations, the process advisor disclosed herein may be used with a business process scenario landscape overview map, although the process advisor may be used with other types of work flow representations as well. The following provides a description of this scenario landscape overview map.

The scenario landscape for an organization can refer to a set including all or some of the business scenarios and/or business processes characterizing an organization's operations. In general, a business scenario can includes one or more business processes, process steps, or other business process features. Business process features can include one or more of business processes, process steps, sub-processes, tasks, activities, and the like. The business scenarios and business processes can be managed, and tasks relating to the completion of one or more steps of the business processes can be supported by, one or more feature modules of a business software architecture, such as for example an enterprise resource planning (ERP) system. The terms “instance of a business process,” “instance of a business scenario,” and similar descriptive terminology is intended to refer to a specific execution of a business process or a business scenario, respectively. For example, for a business scenario relating to sale of a product, each order taken and filled for that product can be considered as an instance of the business scenario. A business configuration can be a set of business scenarios including sets of business processes or business process features supported by the business software architecture and optionally customized to reflect the actual, real-life business functions (e.g. end-to-end business processes) performed by employees or other organization members on a recurring basis. A business configuration for an organization customer of a business software architecture is usually set up upon initial installation with occasional modifications or updates provided to reflect changes to the underlying real-life processes and procedures. Such a business configuration is typically constructed like a catalog, and its functions can be structured according to business areas, packages, topics and options. Once the initial business configuration is set up, all decisions are made, and the scoping is done, the business software architecture is ready for productive usage.

A scenario landscape map such as is described herein can serve as an integrated part of a business software solution and can include one or more of the following capabilities. In some implementations, a scenario landscape map can provide a visualization of business scenarios using a transit-map style, for example using a visual analog to a geographical map in the form of a schematic diagram in which routes and stations of a public transport system represent process flow and actions that are performed in the execution of a business scenario. The scenario landscape map can translate scenario or process flows visualized as route lines into end-to-end business scenarios, and stations or stops visualized as labeled icons into business processes and process steps. A business user or prospective business user can thereby be assisted in efficiently understanding, discussing, and/or adjusting the underlying business scenario model of an business software solution in either or both of the software sales and software implementation cycles. Unlike more technical displays of business process or business scenario information (e.g. business process modeling notation of the like), the scenario landscape map deliberately uses a pre-calculated level of reduced detail and accuracy in representing business scenario model semantics. Instead, the scenario landscape map, which can also be referred to as a scenario browser or the like, makes use of straight lines, fixed angles, and/or other relatively simply geometric shapes, and can make use of an approximately similar, fixed distance between “stops” on the route line (each of which can represent a business process feature) while hiding actual complications (e.g. decision trees, loops, branches, alternative routes, etc.) of the “real” underlying business scenario flow and, optionally, end-to-end scenario dependencies as well. Such an approach can create a simplified, linear abstracted visualization of the underlying software reality that provides just the right degree of detail for business-focused discussions.

Continuing with the analogy to transit maps, non-relevant or less relevant aspects of reality (e.g. pedestrian routes, buildings, rivers, etc.) can be excluded from the visualization to provide only the key information necessary to assist a rider in getting from a starting location to a destination. In a visualization model consistent with implementations of the current subject matter, “stations” (e.g. business process features such as business processes, process steps, sub-processes, etc. represented visually as points along the route line) that serve as interchanges between lines can be thought of as analogous to one or more integration or intersection points between end-to-end business scenarios.

The scenario landscape map or scenario browser need not be a static, “birds eye” view of a business scenario landscape, but can instead serve to focus information that are most relevant to a currently active business scenario, for example by positioning a route line representing the currently active business scenario in the approximate center of a scenario landscape map view with other integrated or intersecting business scenarios that form part of the business scenario landscape displayed in relation to the currently active business scenario. In another example, a most relevant business scenario of a specific role can be positioned in this manner with the most relevant business scenario being represented as a route line in the approximate center of the scenario landscape map view.

A scenario landscape map or process browser can also enable seamless zoom-in and zoom-out across an entire business process model of the organization in a manner similar to electronic geographical maps. A single scenario navigation tool, for example one as described in one or more of the related applications cited above or as described below can also be launched via the scenario landscape map or scenario browser to allow switching from a scenario landscape view to a transactional data processing mode. The scenario landscape map may also be controlled by the process advisor to guide execution of the process.

FIG. 1C illustrates an example of a scenario landscape overview map or scenario browser 100, which includes relational links between a plurality of business processes in a scenario landscape. Each of several business scenarios 102, 104, 106, 110, 112, 114, 116 are shown at a linear overview degree of detail to depict the relations between the different business scenarios 102, 104, 106, 110, 112, 114, 116 in the scenario landscape. In an implementation, the scenario landscape overview map 100 can be modeled as a transit map that shows the place and the function of each business scenario in the scenario landscape as a whole. Intrinsic relation types between the business scenarios 102, 104, 106, 110, 112, 114, 116 can include, but are not limited to, a predecessor scenario, which is defined as a business scenario whose completion is a prerequisite to another business scenario (e.g., business scenario 102, which includes several business processes or other business process features (shown in FIG. 1C as smaller circles) that lead to the initiation of business scenario 104); a successor scenario, which is defined as a business scenario having a predecessor scenario (e.g., business scenario 104, which has business scenario 102 as its predecessor scenario); a joint use scenario, which is defined as a business scenario that shares a common business process or other common business process feature, a common data object, a common responsible entity (e.g., a person, a unit, etc.), a common event, or the like (e.g., business scenarios 106 and 110, which share business process features with business scenario 112; or business scenario 116 and business scenario 104, which share a business process or other business process feature); and a hierarchical use scenario, which is defined as a business scenario that uses another business process or business scenario as a sub-scenario (e.g., business scenario 112, which includes as a branching sub-scenario the business scenario 114). Also as shown in FIG. 1C, the business scenarios and/or the included business processes or business process features can be labeled in a manner similar to stops on a transit map.

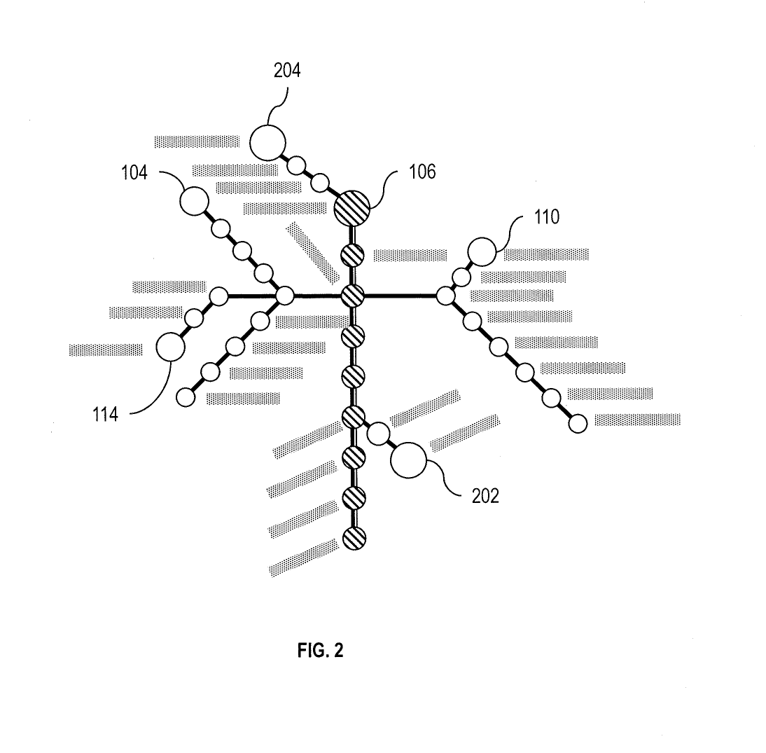

The scenario landscape overview map 100 can advantageously be arranged in a scenario-centric manner, for example such that a selected business scenario 104 is arranged approximately centrally in the overview diagram with other business scenarios (e.g. including but not limited to the business scenario relationships explained in the preceding paragraph) relating to the selected business scenario 104 shown branching or intersecting with the selected business scenario 104. The selected business scenario 104 can optionally be a business scenario that is most relevant to a current role of a user, a currently active business scenario, or the like. The scenario overview map 100 can also advantageously include one or more visual cues to indicate information about the various business scenarios, business processes, and/or the business process features shown in the scenario overview map 100. For example, the route line 120 of the selected business scenario 104 can be shown in a different thickness, with a different pattern, in a different color or brightness, or the like, and the business processes or business process features of the selected business scenario 104 can likewise be shown with a different pattern, color, brightness, etc. Clicking on a business process or business process feature of the selected business scenario 104 can directly navigate a user to a linear single scenario view of the currently active business scenario displayed simultaneously with a work space including user interface elements related to completion, monitoring, etc. of the selected business process or business process feature. Clicking on a business process or business process feature of another scenario besides the selected business scenario 104 can cause the scenario overview map 100 to rearrange to show the scenario landscape with a new scenario-centric view based on the newly selected business scenario, for example as shown in FIG. 2, in which the newly selected process 106 is now arranged approximately centrally in the scenario landscape overview map 100 with other business processes 110, 114, 202, 204, as well as the previously selected business process 104, that are related to the newly selected business process 106 arranged in relation to the newly selected business process 106.

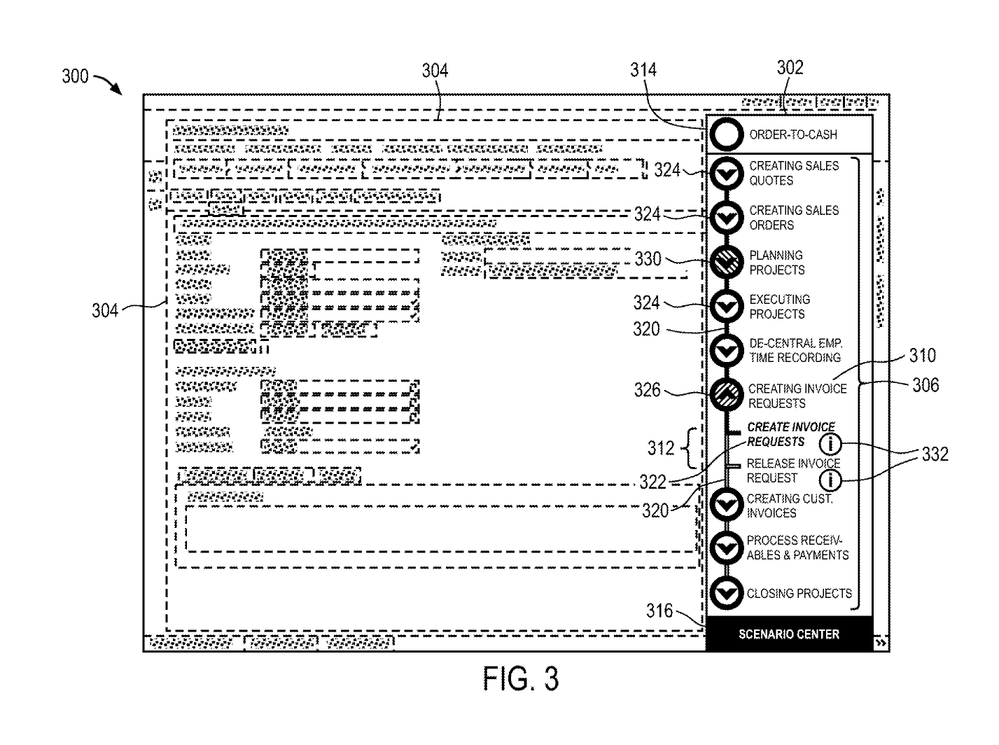

FIG. 3 illustrates an example of a linear single scenario view 300, which shows a single business scenario as a linear sequence of business process features, which can be business processes, process steps, sub-processes, tasks, activities, etc. represented by a set of first user interface features. The structure of the business scenario is condensed into a linear view, even though the actual flow of business process features necessary to complete an instance of the business process often involves explicit parallelism, decisions, loops, event driven changes in control flow, exceptions, and the like. Consistent with the scope of the current subject matter, any viable approach can be used to shape a business scenario into such a linear view.

As shown in FIG. 3, a process navigation pane 302 and a work pane 304 are concurrently displayed. A plurality of first user interface elements 306 are displayed in the process navigation pane 302 and arranged in a linear progression to represent the linear sequence of process steps in the process model of the currently actively business process. A first user interface element 310 corresponding to a business process having additional process steps can be expanded as shown in FIG. 3 to display additional user interface elements 312 corresponding to the process steps. Also as shown in FIG. 3, the currently active business scenario can be identified by one or more scenario identifier user elements 314. A scenario browser user interface element 316 can link to the upper level scenario landscape overview map 100, 200 to display an overall scenario landscape map showing intersections between scenarios and providing links to navigate to the other scenarios in the scenario landscape.

The first user interface elements 306 can be displayed in a manner similar to a transit route map with each process step or sub-step being represented like a stop on the route. In this manner, a familiar visual format can rapidly convey additional information about a current context within a specific instance of the business scenario as well as status information about the various business process features along the “route” to completion of the instance. For example, a route line 320 connecting the “stops” can be presented with a first visual effect (e.g. color, brightness, shade, dots or dashes, etc.) up to the “stop” representing the process step that is currently “active” with related functionality being provided in the work pane 304. The currently active business process feature can be further indicated using textual or visual cues, such as for example color, shading, font, a highlighting box, etc. As a non-limiting example, the name of the business process feature displayed in conjunction with the user interface element 322 corresponding to the currently active process step in FIG. 3 is formatted in a bold and italicized font. A different second visual effect can be used for the remainder of the route line 320 leading to the “stops” past the currently active business process feature. The icons 324 used to represent the “stops” in the scenario navigation pane can also include visual cues to inform a user about status, other business process features that are included within the currently displayed business process or business process feature user interface elements and that can be revealed by a user action to expand the route map, or the like.

Also in the example shown in FIG. 3, the expanded business process 310 is also an intersecting business process that includes additional process steps or other business process features that are part of a second business scenario. The additional business process features are illustrated by first user elements 312 incorporated directly into the route map without branching to maintain the linear progression of the scenario model. The first user interface element 326 representing the “stop” corresponding to this business process can include a different visual presentation than other non-intersecting “stops and can further include other visual presentation features to indicate that it is currently expanded as shown in FIG. 3. The “stop” first user interface element 330 corresponding to another intersecting business process or business process feature (e.g. planning projects in the example of FIG. 3) can include features indicating that it is an intersecting business process or business process feature with expandability, but that it currently is not expanded. Additional first user interface elements 332 (e.g. the “i” icons shown in FIG. 3) can provide additional details about one or more of the business processes or business process features. For example, selection by user of one of these additional user interface elements 332 can cause the user interface to navigate to present a third visualization layer that includes a structured business scenario detail view.

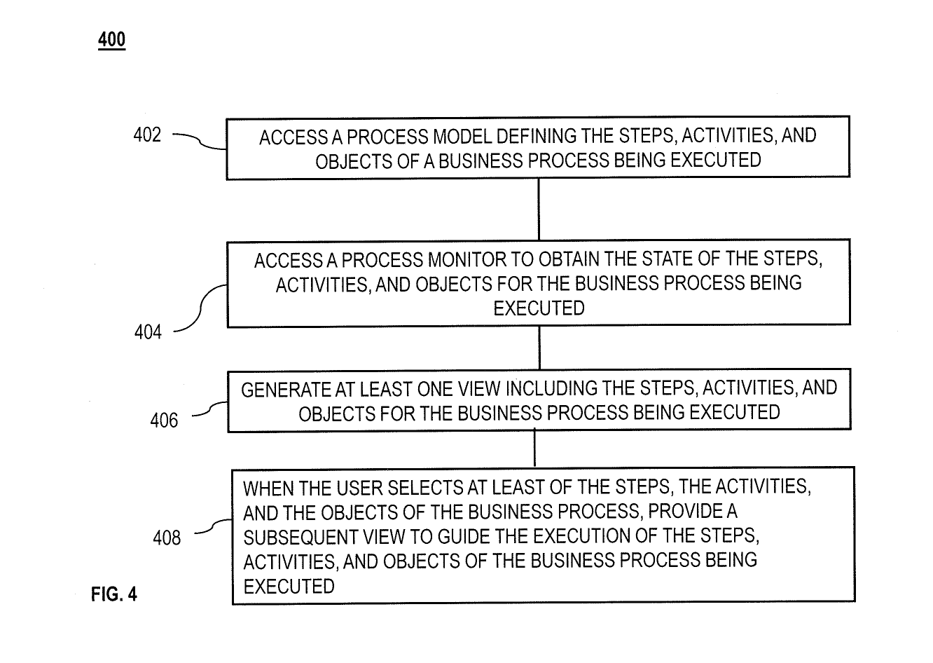

FIG. 4 shows a process flow chart 400 for providing one or more views to guide execution of a business process.

At 402, a process advisor accesses a process model defining the steps, activities, and objects of a business process being executed. For example, process advisor may retrieve from the process model information defining the steps of the business process, such as steps 192A-D, and activities for at least one of the steps, such as activities 194A-F, and objects, such as objects 196A-C.

At 404, the process advisor accesses a process monitor to obtain the state of the steps, activities, and objects for a business process being executed. For example, process advisor may retrieve from the process monitor information defining the state of execution of the steps of the business process. This state information may include status information, such as done, not completed, in progress, amount of competition, and the like.

At 406, the process advisor generates at least one view including the steps, activities, and objects for the business process being executed. For example, process advisor may generate view 198A and send the view to a user interface for presentation. And, when the user selects at least of the steps, the activities, and the objects of the business process, the process advisor may provide, at 408, a subsequent page, such as view 198B, to guide the execution of the steps, activities, and objects of the business process being executed. This subsequent page is also sent to a user interface for presentation. Moreover, the process advisor may generate another view when a step, activity, or task associated with an object is completed. For example, when a step is completed, process advisor may generate another view collapsing the completed task and expanding the next task, as noted above with respect to FIG. 1B.

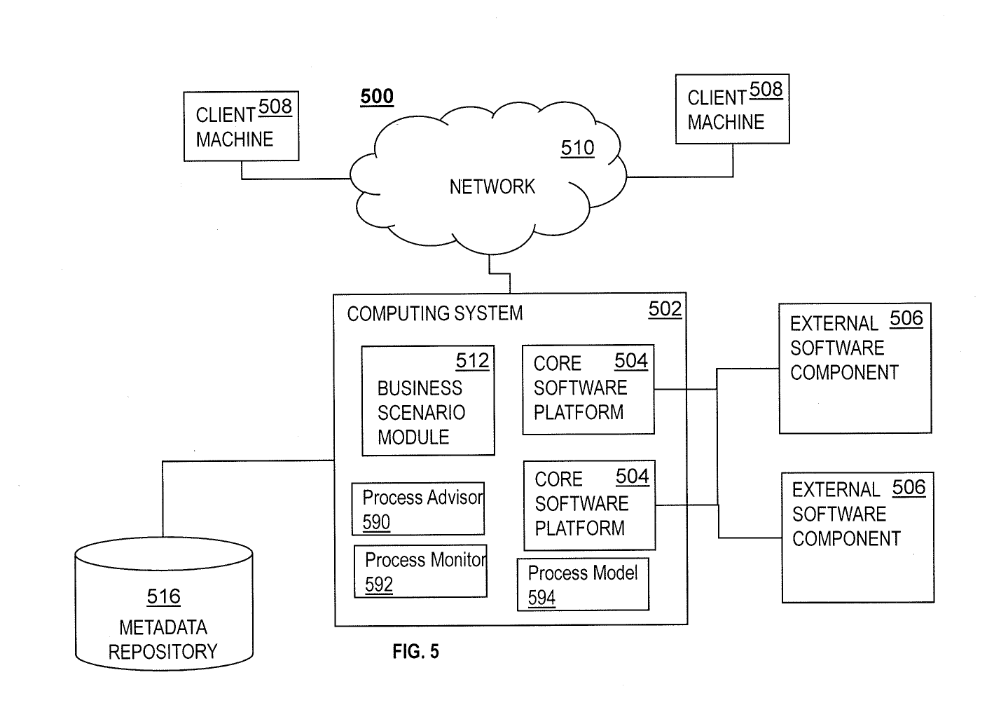

The core software platform of an ERP software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 5 shows a diagram of a system consistent with such an implementation. A computing system 502 can include one or more core software platform modules 504 providing one or more features of the ERP system. The computing system can also aggregate or otherwise provide a gateway via which users can access functionality provided by one or more external software components 506, which can optionally be available from a service provider external to the core software platform modules 504. The computing system 502 may include a process advisor 590, a process monitor 592, and a process model 594 to allow guided execution of business processes being executed by system 500.

Client machines 508 can access the computing system, either via a direct connection, a local terminal, or over a network 510 (e.g. a local area network, a wide area network, a wireless network, the Internet, or the like). A business process guidance and recording module 512 can be hosted on the computing system 502 or alternatively, on an external system accessible over a network connection. The business scenario guidance and recording module 512 can optionally include one or more discrete software and/or hardware modules that perform operations such as those described herein.

The business scenario guidance and recording module 512 can access one or more metadata repositories 516 and/or other data repositories that can store the definition of business process as well as data relating to concrete instances of the data objects (e.g. business objects) that are relevant to a specific instance of the business process. In some examples, the definition can optionally be stored as a business object. In some implementations, the business object can include a template definition of a standard business process. The template definition that can optionally be modified via one or more extensions that are stored in the one or more metadata repositories 516.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

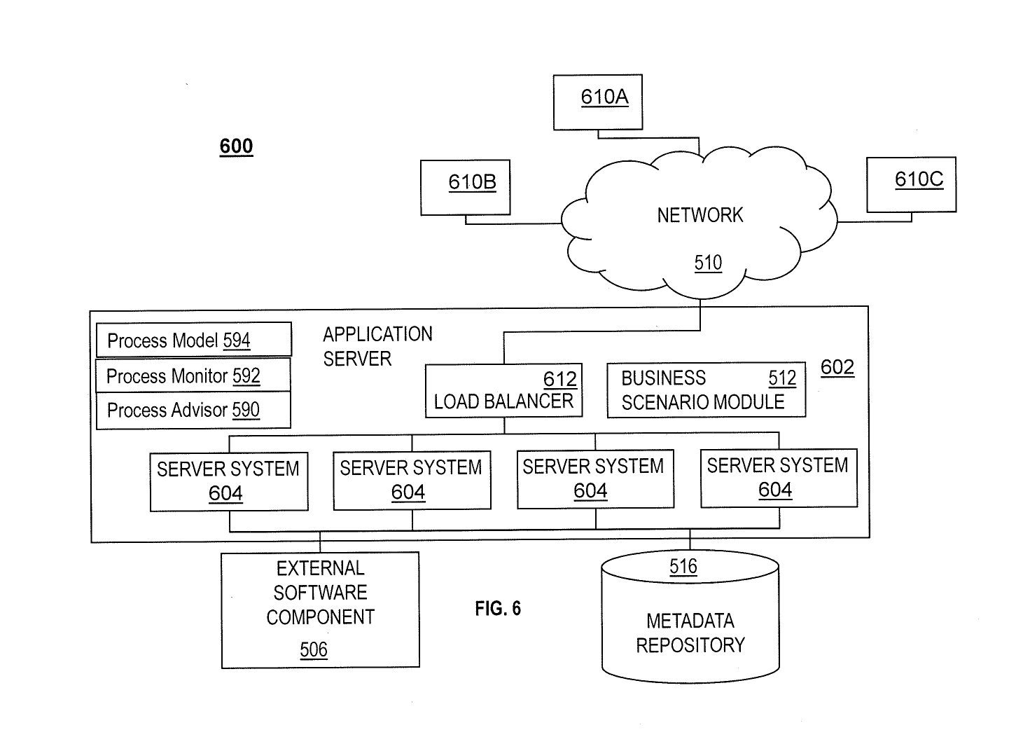

FIG. 6 shows a block diagram of a multi-tenant implementation of a software delivery architecture 600 that includes an application server 602, which can in some implementations include multiple server systems 604 that are accessible over a network 606 from client machines operated by users at each of multiple organizations 610A-610C (referred to herein as “tenants” of a multi-tenant system) supported by a single software delivery architecture 600. FIG. 6 also includes the process advisor 590, the process monitor 592, and the process model 594.

For a system in which the application server 602 includes multiple server systems 604, the application server can include a load balancer 612 to distribute requests and actions from users at the one or more organizations 610A-610C to the one or more server systems 604. Instances of the core software platform 504 (not shown in FIG. 6) can be executed in a distributed manner across the server systems 604. A user can access the software delivery architecture across the network using a thin client, such as for example a web browser or the like, or other portal software running on a client machine. The application server 602 can access data and data objects stored in one or more data repositories 516. The application server 602 can also serve as a middleware component via which access is provided to one or more external software components 506 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 602 that includes multiple server systems 604 that handle processing loads distributed by a load balancer 612. Potential benefits from such an arrangement can include, but are not limited to, high and reliably continuous application server availability and minimization of unplanned downtime, phased updating of the multiple server systems 604 to permit continuous availability (one server system 604 can be taken offline while the other systems continue to provide services via the load balancer 612), scalability via addition or removal of a server system 604 that is accessed via the load balancer 612, and de-coupled lifecycle processes (such as for example system maintenance, software upgrades, etc.) that enable updating of the core software independently of tenant-specific customizations implemented by individual tenants.

As in the example illustrated in FIG. 5, the metadata repository 516 can store a business object that represents a template definition of a standard business process. The repository may also include data associated with the process models disclosed herein. Further, each individual tenant 610A-610C can customize that standard template according to the individual business process features specific to business of the organization to which that tenant is assigned. Customizations can be stored as extensions in the metadata repository.

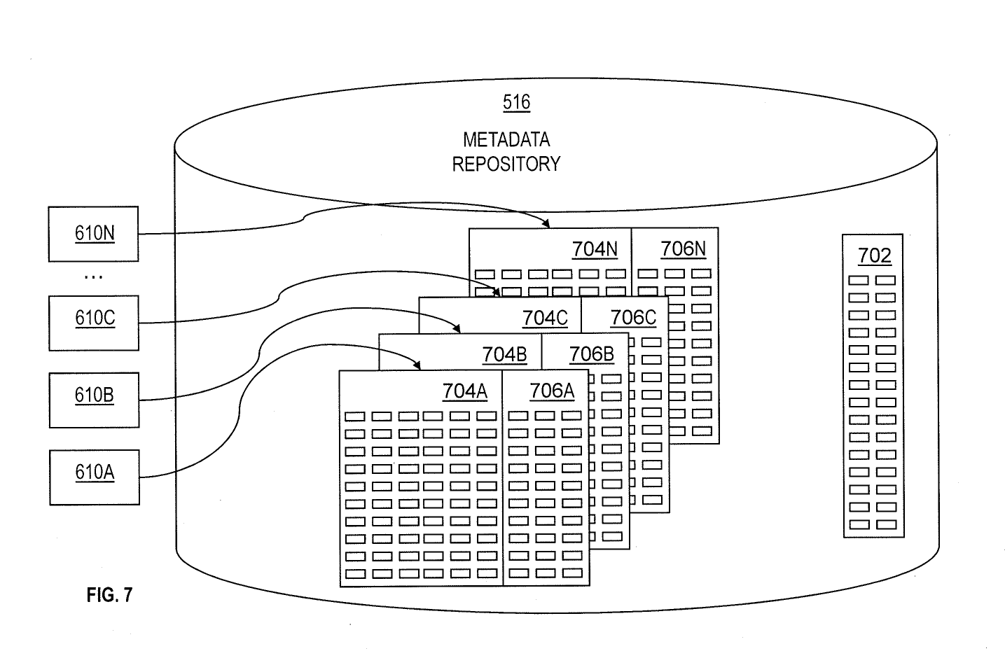

To provide for customization of the business process for each of multiple organizations supported by a single software delivery architecture 600, the data and data objects stored in the metadata repository 516 and/or other data repositories that are accessed by the application server 602 can include three types of content as shown in FIG. 7: core software platform content 702 (e.g. a standard definition of a business process), system content 704 and tenant content 706. Core software platform content 702 includes content that represents core functionality and is not modifiable by a tenant. System content 704 can in some examples be created by the runtime of the core software platform and can include core data objects that store concrete data associated with specific instances of a given business process and that are modifiable with data provided by each tenant. The data retained in these data objects are tenant-specific: for example, each tenant 610A-610N can store information about its own inventory, sales order, etc. Tenant content 706A-706N includes data objects or extensions to other data objects that are customized for one specific tenant 610A-610N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 706 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 702 and system content 704 and tenant content 706 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-readable medium including code that, when executed by at least one programmable processor, cause the at least one programmable processor to perform operations comprising:
accessing a process model defining a business process including a plurality of steps including at least one activity and at least one object;
accessing a process monitor to obtain a state of the business process including the plurality of steps including the at least one activity and the at least one object;
generating a first view including the plurality of steps including the at least one activity and the at least one object and further including the state of the business process; and
generating, based on the state, a second view to guide execution of the business process.

2. The computer-readable medium of claim 1, wherein the accessing further comprises:
determining, by the process monitor, the state of the business process during runtime to determine a runtime state of the business process.

3. The computer-readable medium of claim 1, wherein the at least one object comprises one or more of the following: a document, a link to an application, an application, a query, a work list, and a data item.

4. The computer-readable medium of claim 1 further comprising:
receiving a selection of a graphical element at a user interface, wherein the received selection triggers at least the generating the first view.

5. The computer-readable medium of claim 1 further comprising:
receiving a selection of a graphical element at a user interface, wherein the received selection corresponds to the at least one activity.

6. The computer-readable medium of claim 5 further comprising:
triggering, based on the received selection, the generating of the second view to guide execution of the business process.

7. A system comprising:
at least one processor; and
at least one memory including code that when executed by the at least one processor causes operations comprising:
accessing a process model defining a business process including a plurality of steps including at least one activity and at least one object;
accessing a process monitor to obtain a state of the business process including the plurality of steps including the at least one activity and the at least one object;
generating a first view including the plurality of steps including the at least one activity and the at least one object and further including the state of the business process; and
generating, based on the state, a second view to guide execution of the business process.

8. The system of claim 7, wherein the accessing further comprises:
determining, by the process monitor, the state of the business process during runtime to determine a runtime state of the business process.

9. The system of claim 7, wherein the at least one object comprises one or more of the following: a document, a link to an application, an application, a query, a work list, and a data item.

10. The system of claim 7 further comprising:
receiving a selection of a graphical element at a user interface, wherein the received selection triggers at least the generating the first view.

11. The system of claim 7 further comprising:
receiving a selection of a graphical element at a user interface, wherein the received selection corresponds to the at least one activity.

12. The system of claim 11, further comprising:
triggering, based on the received selection, the generating of the second view to guide execution of the business process.

13. A method comprising:
accessing a process model defining a business process including a plurality of steps including at least one activity and at least one object;
accessing a process monitor to obtain a state of the business process including the plurality of steps including the at least one activity and the at least one object;
generating a first view including the plurality of steps including the at least one activity and the at least one object and further including the state of the business process; and
generating, based on the state, a second view to guide execution of the business process.

14. The method of claim 13, wherein the accessing further comprises:
determining, by the process monitor, the state of the business process during runtime to determine a runtime state of the business process.

15. The method of claim 13, wherein the at least one object comprises one or more of the following: a document, a link to an application, an application, a query, a work list, and a data item.

16. The method of claim 13 further comprising:
receiving a selection of a graphical element at a user interface, wherein the received selection triggers at least the generating the first view.

17. The method of claim 16 further comprising:
receiving a selection of a graphical element at a user interface, wherein the received selection corresponds to the at least one activity.

18. The method of claim 17, further comprising:
triggering, based on the received selection, the generating of the second view to guide execution of the business process.
